(19) United States
(12) Patent Application Publication
(10) Pub. No.: US 2025/0304183 A1
(43) Pub. Date: Oct. 2, 2025

(54) FRONT SIDE BODY OF VEHICLE

(71) Applicants: Hyundai Motor Company, Seoul (KR); Kia Corporation, Seoul (KR)

(72) Inventors: Jong Gwan Yun, Busan (KR); Yong Dok An, Anyang-Si (KR); Do Hoi Kim, Sejong-Si (KR); Mun Soo Cha, Suwon-Si (KR)

(21) Appl. No.: 18/816,483

(22) Filed: Aug. 27, 2024

(30) Foreign Application Priority Data
Mar. 29, 2024 (KR) 10-2024-0043609

(51) Int. Cl. B62D 25/08; B60K 1/04; B62D 25/04; B62D 25/14

(52) U.S. Cl. CPC B62D 25/088; B60K 1/04; B62D 25/04; B62D 25/081; B62D 25/14

(57) ABSTRACT

A body of a vehicle may comprise a front side member extending in a longitudinal direction of the vehicle, a shock absorber housing disposed between front and rear ends of the front side member and connected to the front side member, and a pillar connected to the rear end of the front side member, wherein the front side member, the shock absorber housing, and the pillar are molded integrally with each other.

### CROSS REFERENCE TO RELATED APPLICATIONS

The present application claims priority to Korean Patent Application No. 10-2024-0043609, filed Mar. 29, 2024, the entire contents of which is incorporated herein for all purposes by this reference.

### TECHNICAL FIELD

The present disclosure relates to a front side body constituting a front side part of a vehicle body.

### BACKGROUND

A front side body of a vehicle may be formed by assembling as many as 50 or more parts. To reduce the weight of a vehicle, methods for reducing or minimizing parts of the front side body of a vehicle that has been formed by assembling 50 or more parts are being carried.

If weight reduction of the front side body of a vehicle is realized, the robustness of the body may be weakened, there is a need for the front side body of a vehicle that may realize weight reduction and satisfy minimum robustness thereof.

### SUMMARY

According to the present disclosure, a body of a vehicle may comprise a front side member extending in a longitudinal direction of the vehicle, a shock absorber housing disposed between front and rear ends of the front side member and connected to the front side member, and a pillar connected to the rear end of the front side member, wherein the front side member, the shock absorber housing, and the pillar are molded integrally with each other.

The body, further may comprise a fender apron member having a first end portion connected to the front end of the front side member and a second end portion connected to a front end portion of the shock absorber housing, wherein the fender apron member is molded integrally with the front side member, the shock absorber housing, and the pillar.

The body, wherein one or more selected from a group, may comprise the front side member, the shock absorber housing, and the pillar, comprise mounting parts to which vehicle parts are configured to be coupled.

The body, wherein the mounting parts comprise protrusion bushes, and the vehicle parts are configured to be coupled to the protrusion bushes in an inserted manner. The body, wherein the pillar comprises a dash panel mounting part to which a dash panel is configured to be coupled.

The body, wherein the front side member comprises a sub-frame mounting part to which a sub-frame is configured to be coupled.

The body, wherein one or more selected from a group, may comprise the front side member, the shock absorber housing, and the pillar, comprise battery casing mounting parts to which battery casings equipped with batteries are configured to be coupled.

The body, wherein one or more selected from a group, may comprise the front side member, the shock absorber housing, and the pillar, comprise horizontal ribs and vertical ribs formed to cross each other to create spaces, wherein the horizontal ribs are parallel to the longitudinal direction of the vehicle, and wherein the vertical ribs are vertical to the longitudinal direction of the vehicle.

The body, wherein one or more of points where the horizontal ribs and the vertical ribs cross each other have mounting holes to which vehicle parts are configured to be coupled.

The body, wherein the pillar has a door latch mounting hole to which a door latch is configured to be coupled.

The body, wherein the pillar has a cowl crossbar mounting hole to which a cowl crossbar is configured to be coupled.

The body, wherein one or more selected from a group, may comprise the front side member, the shock absorber housing, and the pillar, comprise diagonal ribs, wherein the diagonal ribs are configured to pass through cross points of the horizontal ribs and the vertical ribs, to partition spaces created by the horizontal ribs and the vertical ribs.

The body, wherein the horizontal ribs and the vertical ribs are configured to create the spaces at the front end of the front side member where the shock absorber housing is disposed, and wherein the horizontal ribs, the vertical ribs, and the diagonal ribs are configured to create the spaces at the rear end.

The body, wherein the spaces created by the horizontal ribs and the vertical ribs crossing each other are configured to face an inside space or an outside space of the vehicle.

The body, wherein a side inner complete part and a side outer complete part are molded integrally with the front side member, the shock absorber housing, and the pillar.

According to the present disclosure, a vehicle may comprise a vehicle body comprising a front side member extending in a longitudinal direction of the vehicle, a shock absorber housing disposed between front and rear ends of the front side member and connected to the front side member, and a pillar connected to the rear end of the front side member, wherein the front side member, the shock absorber housing, and the pillar are molded integrally with each other, and wherein spaces are formed at a front end portion of the front side member, and wherein the front side member is configured to receive a load to the front end portion so that the spaces are deformed and crash impact on the vehicle is reduced.

The vehicle, wherein the front side member is configured to absorb the load and disperse the load uniformly to the vehicle body.

The vehicle, wherein the vehicle body comprises a load transfer path between the front side member, the pillar, and the shock absorber housing.

According to the present disclosure, a method for manufacturing a body of a vehicle, the method may comprise forming a front side member extending in a longitudinal direction of the vehicle, disposing a shock absorber housing between front and rear ends of the front side member and connecting the shock absorber housing to the front side member, connecting a pillar to the rear end of the front side member, and integrally molding the front side member, the shock absorber housing, and the pillar with each other.

The method, further may comprise creating spaces by forming first horizontal ribs and first vertical ribs to cross each other at a front end of the front side member, wherein the first horizontal ribs are parallel to the longitudinal direction of the vehicle, and wherein the first vertical ribs are vertical to the longitudinal direction of the vehicle.

### BRIEF DESCRIPTION OF THE DRAWINGS

FIGS. 1 and 2 show examples of a front side body of a vehicle according to an example of the present disclosure.

FIG. 3 shows an example of a main load path of the front side body of a vehicle.

FIG. 4 shows an example of a mounting part formed in an A-pillar.

FIG. 5 shows an example of the front side body of a vehicle with a dash panel coupled thereto.

FIG. 6 shows an example of an inner surface of the front side body of a vehicle according to the example of the present disclosure.

FIG. 7 shows an example of an outer surface of the front side body of a vehicle according to the example of the present disclosure.

FIG. 8 shows an example of the front side body of a vehicle with a side inner complete part and a side outer complete part molded integrally with the front side body.

### DETAILED DESCRIPTION

Hereafter, examples of the present disclosure will be described in detail with reference to the accompanying drawings and the same or similar components are given the same reference numerals regardless of the numbers of figures and are not repeatedly described.

In the following description, if it is decided that the detailed description of known technologies related to the present disclosure makes the subject matter of the example described herein unclear, the detailed description is omitted. Furthermore, the accompanying drawings are provided only for easy understanding of the example disclosed in the specification, and the technical spirit disclosed in the specification is not limited by the accompanying drawings, and all changes, equivalents, and replacements may be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

Singular forms are intended to include plural forms unless the context clearly indicates otherwise.

It will be further understood that the terms “comprise” or “have” used in this specification, specify the presence of stated features, steps, operations, components, parts, or a combination thereof, but do not preclude the presence or addition of one or more other features, numerals, steps, operations, components, parts, or a combination thereof.

The suffixes “module” and “part” for the components used in the following description are given or mixed in consideration of only the ease of writing the specification, and do not have distinct meanings or roles by themselves.

It is to be understood that if one element is referred to as being “connected to” or “coupled to” another element, it may be connected directly to or coupled directly to another element or be connected to or coupled to another element, having the other element intervening therebetween. On the other hand, it may to be understood that if one element is referred to as being “connected directly to” or “coupled directly to” another element, it may be connected to or coupled to another element without the other element intervening therebetween.

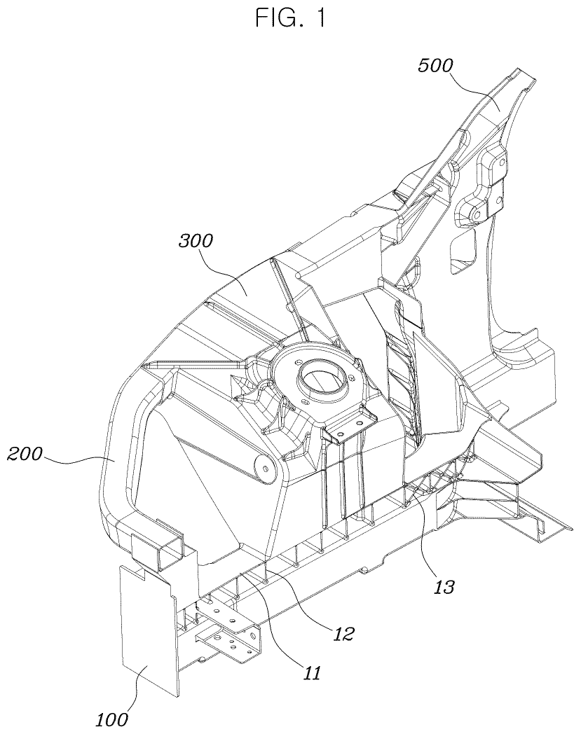

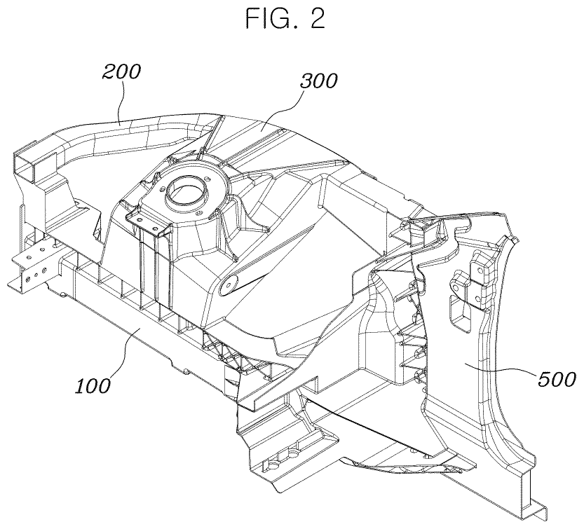

FIGS. 1 and 2 show examples of a front side body of a vehicle according to an example of the present disclosure.

Referring to FIGS. 1 and 2, according to the example of the present disclosure, the front side body of a vehicle includes a front side member 100, a shock absorber housing 300, and an A-pillar 500. Specifically, the front side body of a vehicle is characterized in that the front side member 100, the shock absorber housing 300, and the A-pillar 500 are molded integrally with each other.

More specifically, the front side body of a vehicle is a side structure of a vehicle that extends from the front end of the vehicle to the rear end. The front side body absorbs a load (energy) during a forward collision of a vehicle and disperses the load uniformly to the entire vehicle body to protect a passenger from the collision. In the specification, although the A-pillar 500 is partially shown, it may mean the entire A-pillar or a portion of the A-pillar. In the case of a portion of the A-pillar, a portion of the A-pillar may be interpreted as an A-pillar connection point to which an A-pillar is connected and a separately produced A-pillar is coupled to the A-pillar connection point, thereby constituting an A-pillar of a vehicle.

The front side body of a vehicle may be produced by various parts welded together as well as the front side member, the shock absorber housing, and the A-pillar. In this process, about 30 to 50 or more parts may be coupled to each other in a welding manner.

In the welding-type manufacturing method of the front side body of a vehicle, many flanges may be formed to couple the parts to each other. The flanges are causes of increasing the weight of the front side body of a vehicle. Furthermore, since numerous parts may be manufactured separately, the time and the amount of work required for manufacturing the parts increase, which is a disadvantage.

In the present disclosure, as a part of the front side body of a vehicle is molded to be integrated, welding between parts may be minimized or reduced and the weight of the front side body of a vehicle is reduced simultaneously so that the above problem may be removed.

Specifically, the front side body of a vehicle is characterized to mold integrally the front side member 100, the shock absorber housing 300, and the A-pillar 500 that occupy large volumes in the front side body.

According to the relevant method, since the front side member 100, the shock absorber housing 300, and the A-pillar 500 which occupy most volume in the front side body of a vehicle are molded integrally with each other, welded surfaces may be minimized or reduced. The front side member 100, shock absorber housing 300, and A-pillar 500 could be integrally molded using polypropylene through injection molding for a lightweight, impact-resistant component, using epoxy resin in compression molding to create a strong, heat-resistant integral part, or using resin transfer molding with carbon fiber reinforced plastic for high strength and reduced weight.

The more welded surfaces the front side body has, the more likely it is that the welded surfaces will break due to a load. If a welded surface breaks, it is difficult to transfer the load. If an excessive load is concentrated to a specific portion, another welded surface may break and it is difficult to disperse the load.

However, the relevant method has an advantage of appropriately achieving load transfer and dispersion by minimizing or reducing welded surfaces.

In the front side body of a vehicle according to the present disclosure, the left front side body and the right front side body are provided symmetrically or substantially symmetrically each other and are connected to each other by a crossbar, etc. A space between the left front side body and the right front side body may be provided as an engine room or a space equipped with power electronic parts (e.g., inverter, converter, motor controller, power distribution unit, high-voltage wiring and connectors, auxiliary power modules, charging interface, etc.) of an electric vehicle.

Moreover, according to the present disclosure, a fender apron member 200 may also be molded integrally with the front side body of a vehicle. A first end of the fender apron member 200 is connected to a front end of the front side member 100, and a second end of the fender apron member 200 may be connected to a front end portion of the shock absorber housing 300. The fender apron member 200 could be integrally molded with the front side body of a vehicle using polypropylene through injection molding for a lightweight, impact-resistant component, using epoxy resin in compression molding to create a strong, heat-resistant integral part, or using resin transfer molding with carbon fiber reinforced plastic for high strength and reduced weight.

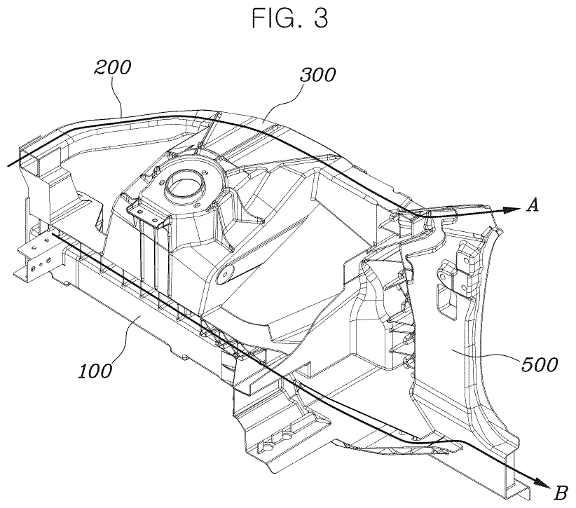

With the integrally molded fender apron member 200, in the event of a forward collision of a vehicle, a load transfer path may be formed as shown in FIG. 3. In other words, a shock applied to the front side member 100 may move to the A-pillar 500 through the fender apron member 200 and the shock absorber housing 300 (A).

In addition or alternative, a shock applied to the front side member 100 may be directly moved to the A-pillar 500 (B) after passing through the front side member 100.

An A-pillar outer is coupled to one end portion of the A-pillar 500, and a side sill may be coupled to another end portion of the A-pillar 500. Therefore, a load transferred to the A-pillar 500 may be moved to the A-pillar and the side sill and may be transferred to a B-pillar and a C-pillar.

As described above, the front side member 100, the shock absorber housing 300, the A-pillar 500, and the fender apron member 200 are molded integrally with each other, thereby preventing welding lines or welding surfaces from being created, so there is no disconnection in the load transfer path. Therefore, a load if a vehicle forward collision occurs may be naturally moved to the A-pillar 500, and the load may be uniformly dispersed to the entire vehicle body.

Meanwhile, one or more selected from a group comprising the front side member 100, the shock absorber housing 300, and the A-pillar 500 may have mounting parts 400 to which vehicle parts.

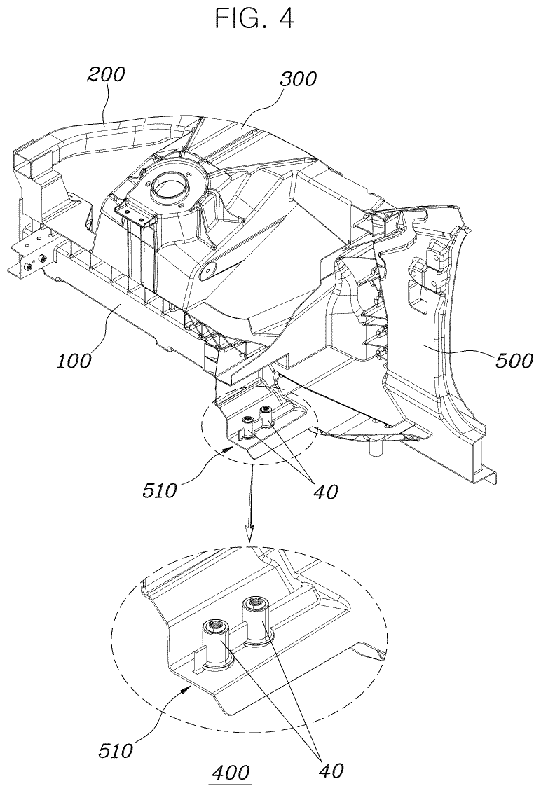

FIG. 4 shows an example of a mounting part formed in an A-pillar. Referring to FIG. 4, the mounting parts 400 may have protrusion bushes 40, and vehicle parts coupled to the front side body may be coupled to the protrusion bushes 40 in an inserted manner. If vehicle parts are inserted into the protrusion bushes 40, the vehicle parts are welded to realize robust coupling.

For example, a dash panel, a sub-frame, and a battery casing equipped with a battery may be provided as the vehicle parts.

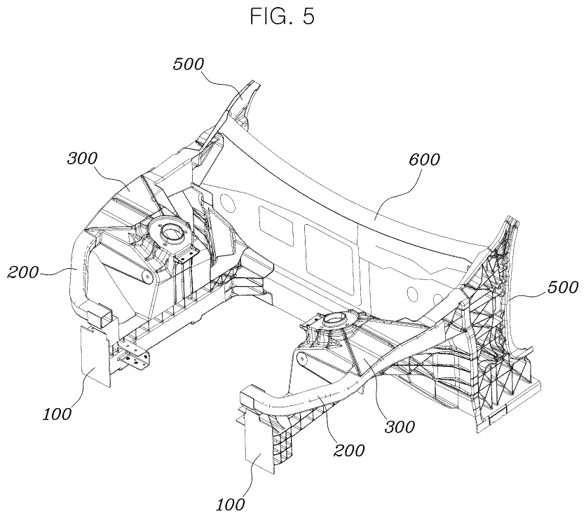

A dash panel 600 is a component that prevents noise generated due to driving the vehicle from being transmitted into the vehicle. As shown in FIG. 5, the dash panel 600 is coupled to the pair of front side bodies of the vehicle and serves to connect the pair of front side bodies of the vehicle.

The dash panel 600 is coupled to a dash panel mounting part 510 formed in the A-pillar 500 in the inserted manner and then welded, so the dash panel 600 may be robustly coupled to the A-pillar 500.

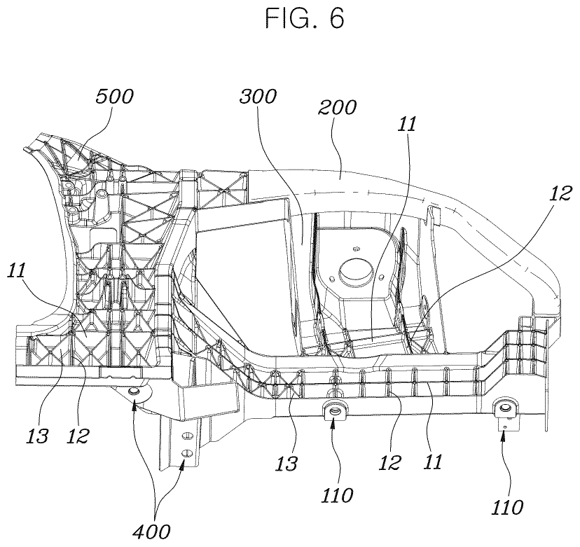

In addition or alternative, referring to FIG. 6, the front side member 100 may have a sub-frame mounting part 110 to which the sub-frame is coupled, and the sub-frame is coupled to the front side member to support a load of an engine and/or a transmission.

In addition or alternative, if a vehicle is not an internal-combustion engine vehicle but is an electric vehicle driven by a battery and a motor, battery casing mounting parts may be formed in one or more selected from a group comprising the front side member 100, the shock absorber housing 300, and the A-pillar 500, and the battery casing equipped with the battery is coupled to each of the battery casing mounting parts.

As described above, the mounting parts 400 are welded after being coupled with the vehicle parts in the inserted manner, so it is possible to secure the robustness with respect to a load applied in a transverse direction, a longitudinal direction (e.g., a driving direction of a vehicle), and a height or vertical direction of a vehicle.

Meanwhile, in one or more selected from a group comprising the front side member 100, the shock absorber housing 300, and the A-pillar 500 that are molded integrally with each other, horizontal ribs 11 and vertical ribs 12 are formed to cross each other to create or form spaces.

The front side body of a vehicle of the present disclosure is manufactured by integrally molding some of the parts constituting a base thereof, and the front side body is molded in one body, thereby having an open section. If molding the front side body, the front side body of a vehicle may be manufactured by injecting an alloy containing aluminum and/or magnesium into a mold or by injecting steel into a mold.

An open section may be less robust than a closed section. Therefore, in order to secure the robustness of the front side body of a vehicle, the horizontal ribs 11 and the vertical ribs 12 may be formed in one or more selected from a group comprising the front side member 100, the shock absorber housing 300, and the A-pillar 500.

The horizontal ribs 11 and the vertical ribs 12 cross each other, thereby creating spaces in the front side member 100, the shock absorber housing 300, and the A-pillar 500. The horizontal ribs 11 and the vertical ribs 12 may effectively disperse stress applied to the vehicle body, partially absorb stress, and increase the robustness of the open section. Furthermore, the spaces created by the horizontal ribs 11 and the vertical ribs 12 may absorb a load generated during a collision while providing a space that enables the vehicle body to be deformed due to the collision.

At this point, the spaces created by the horizontal ribs 11 and the vertical ribs 12 crossing each other may be formed to face the inside space or the outside space of the vehicle. In other words, the horizontal ribs 11 and the vertical ribs 12 are formed at the left side or the right side of the vehicle body based on the transverse direction of the vehicle, so that the spaces are formed to face the inside space or the outside space of the vehicle.

Alternatively or additionally, spaces may be created by a honeycomb structure, where a hexagonal grid pattern may be used to create the honeycomb structure for more uniform load distribution. Alternatively or additionally, spaces may be created by corrugated or wave-like patterns creating alternating ridges and grooves, by a series of interconnected triangular elements forming a truss structure, by a grid-like lattice structure with crisscrossing elements, by using foam inserts within molded parts, by integrating hollow tubes, or by using panels with a series of holes or perforations, etc.

FIG. 6 shows an example of an inner surface of the front side body of a vehicle according to the example of the present disclosure. Referring to FIG. 6, it is shown that the horizontal ribs 11 and the vertical ribs 12 form multiple spaces in the front side member 100, the shock absorber housing 300, and the A-pillar 500 so that the spaces face the outside space of the vehicle.

In addition or alternative, referring to FIG. 1, it may be confirmed that the horizontal ribs 11 and the vertical ribs 12 are formed at multiple points of the front side member 100 to face the inside space of the vehicle.

Specifically, referring to FIG. 6, in the front end of the front side member 100 of the front side body of a vehicle that is molded integrally, the multiple horizontal ribs 11 and the multiple vertical ribs 12 are formed to cross each other to create spaces.

If a forward or substantially forward collision occurs, a portion where a load is applied first is the front end of the front side member 100. Therefore, the front end of the front side member 100 may appropriately transfer and disperse a load while being sufficiently deformed. To this end, the horizontal ribs 11 and the vertical ribs 12 are formed to cross each other from the front end of the front side member 100, and because of this, the front side body of a vehicle has spaces facing the inside space or the outside space of the vehicle.

The corresponding spaces guide the front side member 100 to be sufficiently deformed by a load generated during a forward collision of the vehicle. On the other hand, sufficient spaces are used for deforming the front side member 100 by a load. The front side member 100 may be sufficiently deformed through the spaces created by the horizontal ribs 11 and the vertical ribs 12, and the load may be efficiently transferred to the A-pillar 500 with sufficient deformation.

Meanwhile, diagonal ribs 13 may be formed in one or more selected from a group comprising the front side member 100, the shock absorber housing 300, and the A-pillar 500, and the diagonal ribs 13 pass through cross points of the horizontal ribs 11 and the vertical ribs 12.

Due to the provision of the diagonal ribs 13, the spaces created by the horizontal ribs 11 and the vertical ribs 12 are partitioned to increase the sectional areas of the vehicle body, and the front side body of a vehicle may secure greater robustness.

Due to the provision of the diagonal ribs 13, the front side body of a vehicle obtains additional robustness, thereby reducing the degree of deformation caused by a load. The sufficient deformation of the front side body of a vehicle is to transfer and disperse a load, but continuous deformation of the vehicle body may cause physical injury to the passenger. Specifically, in case of a vehicle body located close to a passenger, the degree of deformation may be reduced to protect a passenger from a forward collision.

In other words, the front end of the front side member 100 located relatively far from the passenger may enable the vehicle body to be sufficiently deformed while having the horizontal ribs 11 and the vertical ribs 12, so a load may be efficiently transferred to the A-pillar 500 and be dispersed. At this point, the front end of the front side member 100 may include parts from the foremost end of the front side member 100 to a portion where the shock absorber housing may be disposed.

On the other hand, since a portion behind a portion where the shock absorber housing 300 of the front side member 100 is arranged is a portion where the front side body of a vehicle is located relatively close to the passenger, the passenger may be protected from deformation of the vehicle body by further reducing the degree of deformation of the vehicle body.

Therefore, the diagonal ribs 13 may be formed in the rear end of the front side member 100 relatively close to the passenger to secure additional robustness and reduce the degree of deformation of the vehicle body lower than the front end of the front side member 100 to prevent the passenger from injury by vehicle body deformation.

Not only the front side member 100 but also the A-pillar 500 may have additional diagonal ribs 13 to prevent the passenger from injury by vehicle body deformation.

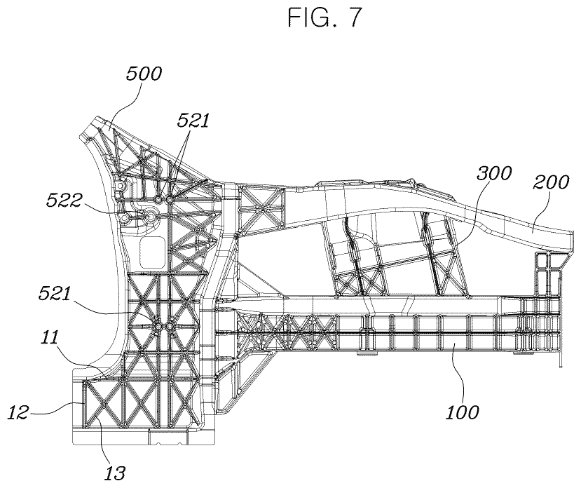

Meanwhile, a door latch and a cowl crossbar that constitute the vehicle may be coupled to the front side body of a vehicle. Referring to FIG. 7, mounting holes 521 and 522 may be formed to couple the door latch and the cowl crossbar to the front side body of a vehicle.

At this point, the door latch and the cowl crossbar may be coupled to the A-pillar 500, and the mounting holes 521 and 522 are formed at some of the points of the A-pillar 500 where the horizontal ribs 11 and the vertical ribs 12 cross each other so that the door latch and the cowl crossbar may be coupled to the A-pillar 500 through the mounting holes 521 and 522.

The door latch mounting holes 521 and the cowl crossbar mounting hole 522 may be formed at the points where the horizontal ribs 11 and the vertical ribs 12 cross each other, and if the mounting holes 521 and 522 are formed at the points where the horizontal ribs 11 and the vertical ribs 12 cross each other, it is possible to secure sufficient robustness between parts coupled to the front side body of a vehicle, which is an advantage.

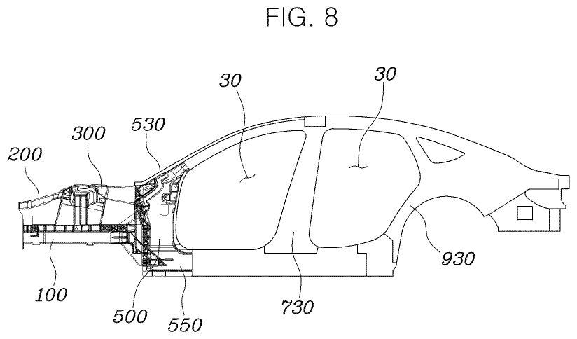

Meanwhile, referring to FIG. 8, the front side body of a vehicle according to the present disclosure is manufactured by integrally molding the front side member 100 to the A-pillar 500 constituting a part of the A-pillar 530 and a part of the side sill 550. Moreover, the left and right side vehicle bodies may be integrated by integrally molding a side inner complete part 700 including an inner of the B-pillar 730 and an inner of the C-pillar 930 to a side outer complete part 900 including an outer of the B-pillar 730 and an outer of the C-pillar 930.

In other words, the side inner complete part 700 and the side outer complete part 900 may include open parts 30 to which the side sill 550 and a door are coupled. In addition or alternative, since the side outer complete part panel 900 may also be molded to integrate the side body of a vehicle, the time and the amount of work required for manufacturing the vehicle body may be significantly reduced, which is an advantage.

The present disclosure is proposed to provide a front side body of a vehicle, the front side body being capable of simultaneously reducing weight and protecting a passenger during a forward collision of a vehicle.

According to an example of the present disclosure, there is provided a front side body of a vehicle, the front side body including: a front side member extending in a longitudinal direction of a vehicle; a shock absorber housing disposed between front and rear ends of the front side member and connected to the front side member; and an A-pillar connected to the rear end of the front side member, wherein the front side member, the shock absorber housing, and the A-pillar may be molded integrally with each other.

The front side body may include: a fender apron member having a first end portion connected to the front end of the front side member and a second end portion connected to a front end portion of the shock absorber housing, wherein the fender apron member may be molded integrally with the front side member, the shock absorber housing, and the A-pillar.

One or more selected from a group comprising the front side member, the shock absorber housing, and the A-pillar may include mounting parts to which vehicle parts are coupled.

The mounting parts may include protrusion bushes, and the vehicle parts may be coupled to the protrusion bushes in an inserted manner.

The A-pillar may include a dash panel mounting part to which a dash panel may be coupled.

The front side member may include a sub-frame mounting part to which a sub-frame may be coupled.

One or more selected from a group comprising the front side member, the shock absorber housing, and the A-pillar may include battery casing mounting parts to which battery casings equipped with batteries may be coupled.

One or more selected from a group comprising the front side member, the shock absorber housing, and the A-pillar molded integrally with each other may be horizontal ribs and vertical ribs formed to cross each other to create spaces.

Some of the points where the horizontal ribs and the vertical ribs cross each other may have mounting holes to which vehicle parts may be coupled.

The A-pillar may have a door latch mounting hole to which a door latch may be coupled.

The A-pillar may have a cowl crossbar mounting hole to which a cowl crossbar may be coupled.

One or more selected from a group comprising the front side member, the shock absorber housing, and the A-pillar may include diagonal ribs, the diagonal ribs passing through cross points of the horizontal ribs and the vertical ribs, to partition the spaces created by the horizontal ribs and the vertical ribs.

The horizontal ribs and the vertical ribs may create the spaces at the front end of the front side member where the shock absorber housing is disposed, and the horizontal ribs, the vertical ribs, and the diagonal ribs may create the spaces at the rear end thereof.

The spaces created by the horizontal ribs and the vertical ribs crossing each other may be arranged to face an inside space or an outside space of the vehicle.

A side inner complete part and a side outer complete part may be molded integrally with the front side member, the shock absorber housing, and the A-pillar.

According to the present disclosure, the front side member, the shock absorber housing, and the A-pillar are molded integrally with each other, so that the weight reduction front side body of a vehicle may be provided.

Moreover, the fender apron member is also molded integrally together, so that a lighter weight front side body of a vehicle may be provided.

Furthermore, the side inner complete part including a B-pillar and the side outer complete part including a C-pillar are molded integrally with the front side member, the shock absorber housing, and the A-pillar, so that a vehicle side part may be integrated.

One or more selected from a group comprising the front side member, the shock absorber housing, and the A-pillar have the horizontal ribs and the vertical ribs formed to cross each other to form spaces, thereby inducing sufficient deformation of a vehicle body during a forward collision of the vehicle. Some of the points where the horizontal ribs and the vertical ribs cross each other have the diagonal ribs to increase robustness further to reduce the degree of deformation, thereby protecting a passenger from an external impact.

Although the present disclosure was provided above in relation to specific examples shown in the drawings, it is apparent to those skilled in the art that the present disclosure may be changed and modified in various ways without departing from the scope of the present disclosure, which is provided in the following claims.

What is claimed is:

1. A body of a vehicle comprising:
a front side member extending in a longitudinal direction of the vehicle;
a shock absorber housing disposed between front and rear ends of the front side member and connected to the front side member; and
a pillar connected to the rear end of the front side member,
wherein the front side member, the shock absorber housing, and the pillar are molded integrally with each other.

2. The body of claim 1, further comprising:
a fender apron member having a first end portion connected to the front end of the front side member and a second end portion connected to a front end portion of the shock absorber housing,
wherein the fender apron member is molded integrally with the front side member, the shock absorber housing, and the pillar.

3. The body of claim 1, wherein one or more selected from a group, comprising the front side member, the shock absorber housing, and the pillar, comprise mounting parts to which vehicle parts are configured to be coupled.

4. The body of claim 3, wherein the mounting parts comprise protrusion bushes, and the vehicle parts are configured to be coupled to the protrusion bushes in an inserted manner.

5. The body of claim 3, wherein the pillar comprises a dash panel mounting part to which a dash panel is configured to be coupled.

6. The body of claim 3, wherein the front side member comprises a sub-frame mounting part to which a sub-frame is configured to be coupled.

7. The body of claim 3, wherein one or more selected from a group, comprising the front side member, the shock absorber housing, and the pillar, comprise battery casing mounting parts to which battery casings equipped with batteries are configured to be coupled.

8. The body of claim 1, wherein one or more selected from a group, comprising the front side member, the shock absorber housing, and the pillar, comprise horizontal ribs and vertical ribs formed to cross each other to create spaces, wherein the horizontal ribs are parallel to the longitudinal direction of the vehicle, and wherein the vertical ribs are vertical to the longitudinal direction of the vehicle.

9. The body of claim 8, wherein one or more of points where the horizontal ribs and the vertical ribs cross each other have mounting holes to which vehicle parts are configured to be coupled.

10. The body of claim 9, wherein the pillar has a door latch mounting hole to which a door latch is configured to be coupled.

11. The body of claim 9, wherein the pillar has a cowl crossbar mounting hole to which a cowl crossbar is configured to be coupled.

12. The body of claim 8, wherein one or more selected from a group, comprising the front side member, the shock absorber housing, and the pillar, comprise diagonal ribs, wherein the diagonal ribs are configured to pass through cross points of the horizontal ribs and the vertical ribs, to partition spaces created by the horizontal ribs and the vertical ribs.

13. The body of claim 12, wherein the horizontal ribs and the vertical ribs are configured to create the spaces at the front end of the front side member where the shock absorber housing is disposed, and wherein the horizontal ribs, the vertical ribs, and the diagonal ribs are configured to create the spaces at the rear end.

14. The body of claim 8, wherein the spaces created by the horizontal ribs and the vertical ribs crossing each other are configured to face an inside space or an outside space of the vehicle.

15. The body of claim 1, wherein a side inner complete part and a side outer complete part are molded integrally with the front side member, the shock absorber housing, and the pillar.

16. A vehicle comprising:
a vehicle body comprising:
a front side member extending in a longitudinal direction of the vehicle;
a shock absorber housing disposed between front and rear ends of the front side member and connected to the front side member; and
a pillar connected to the rear end of the front side member,
wherein the front side member, the shock absorber housing, and the pillar are molded integrally with each other, and wherein spaces are formed at a front end portion of the front side member; and
wherein the front side member is configured to receive a load to the front end portion so that the spaces are deformed and crash impact on the vehicle is reduced.

17. The vehicle of claim 16, wherein:
the front side member is configured to absorb the load and disperse the load uniformly to the vehicle body.

18. The vehicle of claim 16, wherein the vehicle body comprise a load transfer path between the front side member, the pillar, and the shock absorber housing.

19. A method for manufacturing a body of a vehicle, the method comprising:
forming a front side member extending in a longitudinal direction of the vehicle;
disposing a shock absorber housing between front and rear ends of the front side member and connecting the shock absorber housing to the front side member;
connecting a pillar to the rear end of the front side member; and
integrally molding the front side member, the shock absorber housing, and the pillar with each other.

20. The method of claim 19, further comprising:
creating spaces by forming first horizontal ribs and first vertical ribs to cross each other at a front end of the front side member, wherein the first horizontal ribs are parallel to the longitudinal direction of the vehicle, and wherein the first vertical ribs are vertical to the the longitudinal direction of the vehicle.
